(19) United States
(12) Patent Application Publication
(10) Pub. No.: US 2013/0202097 A1
(43) Pub. Date: Aug. 8, 2013

(54) PRIORITY TELEPHONIC COMMUNICATIONS

(71) Applicant: Michael Steele Schultz, Enola, PA (US)

(72) Inventor: Michael Steele Schultz, Enola, PA (US)

(73) Assignee: Microsoft Corporation, Redmond, WA (US)

(21) Appl. No.: 13/366,599

(22) Filed: Feb. 6, 2012

(51) Int. Cl. H04M 11/00; H04M 3/42

(52) U.S. Cl. 379/93.17; 379/201.02; 379/93.01

(57) ABSTRACT

This document describes various techniques enabling priority telephonic communications. In some embodiments, these techniques enable a person making a telephone call to indicate that their call is important and a person receiving the call to know, even before taking that call, that the call is important.

### BACKGROUND

Typically, when one person wants to call another person, he or she enters a telephone number into his or her phone. A communication network receives that telephone number and then rings the appropriate person's telephone. To begin communicating, the person receiving the call picks up the phone. Many call recipients, however, desire more information by which to decide whether or not they want to pick up the phone.

Recently, methods have been developed that aid recipients in making this decision of whether or not to pick up the phone. These methods do so by providing some information about who may be calling. Some of these methods provide a “caller ID” on a display of the recipient's telephone, which is generally a telephone number or name associated with the telephone number that initiated the call. Some other methods identify the initiating telephone or associated person with an identifying ring tone and the like. These methods, however, only partially address the underlying recipient's desire to decide whether or not to pick up the phone.

### SUMMARY

This document describes various techniques enabling priority telephone communications. With these techniques, a call recipient may better decide whether or not to “pick up the phone” or otherwise accept the call. The techniques may do so, whether alone or with a form of “caller ID,” by enabling a recipient to know, before accepting the call, about the call's priority.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit of a reference number identifies the figure in which the reference number first appears. The use of the same reference number in different instances in the description and the figures may indicate similar or identical items.

FIG. 1 illustrates an example environment in which techniques for priority telephonic communication are implemented.

FIG. 2 illustrates examples of the communication network and the telephonic devices of FIG. 1.

FIG. 3 illustrates a flow diagram depicting example methods for priority telephonic communications from the perspective of a call-initiating telephonic device having computational abilities.

FIG. 4 illustrates a flow diagram depicting example methods for priority telephonic communications from the perspective of an entity acting between a caller and a receiver.

FIG. 5 illustrates a flow diagram depicting example methods for priority telephonic communications from the perspective of a call-receiving telephonic computing device.

FIG. 6 illustrates an example device in which techniques enabling priority telephonic communications can be implemented.

### DETAILED DESCRIPTION

Overview

This document describes various techniques enabling priority telephonic communications. In some embodiments, these techniques enable a person making a telephone call to indicate that their call is important and a person receiving the call to know, even before taking that call, that the call is important. Consider, for example, a man named John and his daughter Lydia. Assume that Lydia needs to get ahold of her Dad immediately because her car has broken down and she needs his help. Assume also that John is in an important business meeting and so he would not normally take a call from Lydia; he would instead wait until after the meeting to call her back. If John knew it was important, however, he would of course take Lydia's call. The techniques can enable Lydia to indicate that her call is important and John to know, with confidence, that it is important, even if either or both of Lydia's and John's phones are basic, non-computing telephones.

This is but one example of how techniques and/or apparatuses enabling priority telephonic communications can be implemented. Techniques and/or apparatuses that enable priority telephonic communication are referred to herein separately or in conjunction as the “techniques” as permitted by the context. This document now turns to an example environment in which the techniques can be embodied, then various example methods for performing the techniques are described, after which an example device is described.

Example Environment

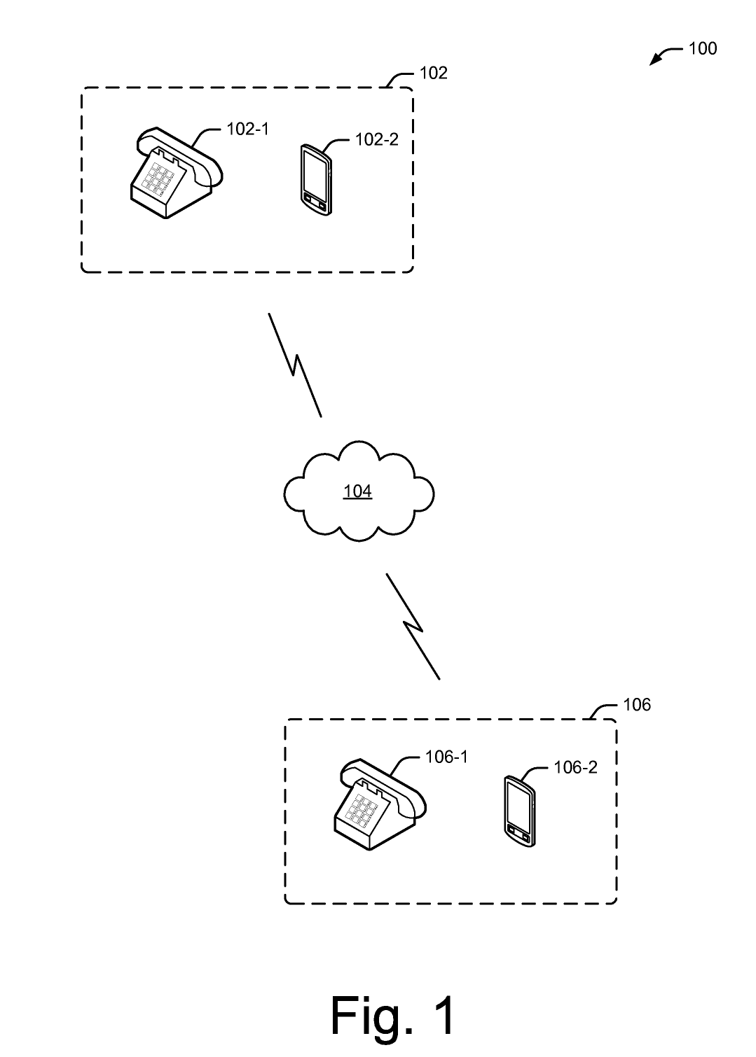

FIG. 1 illustrates an example environment 100 in which techniques for priority telephonic communications can be implemented. Environment 100 includes a call-initiating telephonic device 102, a communications network 104 through which calls and/or other communications are made, and a call-receiving telephonic device 106.

Call-initiating telephonic device 102, hereinafter “calling device 102,” may be a basic call-initiating telephone 102-1, which is unable to perform computations or send texts or emails or be a call-initiating telephonic computing device 102-2 capable of computations and/or sending texts or emails, such as many cellular phones, smart phones, and other computing devices capable of initiating telephone calls. Telephone calls include, but are not limited to, one-to-one and multi-party voice and voice-and-video communications (e.g., video teleconferencing and one-to-one computer-to-computer video and voice communications), including those enabled through basic telephones, smart phones, computers, and so forth. In the example environment, calling device 102 is illustrated with these two examples, though calling device 102 may be another device, such as a basic cellular phone, a cordless phone, a wireless Voice-over-IP phone, or a voice-capable personal media device, to name a few.

Communications network 104 may include any suitable network capable of enabling audio communications, such as a cellular network, a wireless local-area network, a wireless wide-area network, and/or a short-range wireless-network, to name a few. Additionally, in at least some instances, communications network 104 may be managed by a communication service provider/carrier, such as a cellular service provider, Internet service provider, telephone carrier, and/or Voice-over-IP provider in order to facilitate voice communication between calling device 102 and call-receiving telephonic device 106. Note that this service carrier may be a cloud or server-based service local or external to communications network 104.

Call-receiving telephonic device 106, hereinafter “receiving device 106,” similar to calling device 102, may be a call-receiving basic telephone 106-1, which is unable to perform computations or receive texts or emails or a call-receiving telephonic computing device 106-2 capable of computations and/or receiving texts or emails. In the example environment, receiving device 106 is illustrated with these example devices, though receiving device 106 may instead be other devices similar to as noted for calling device 102 above.

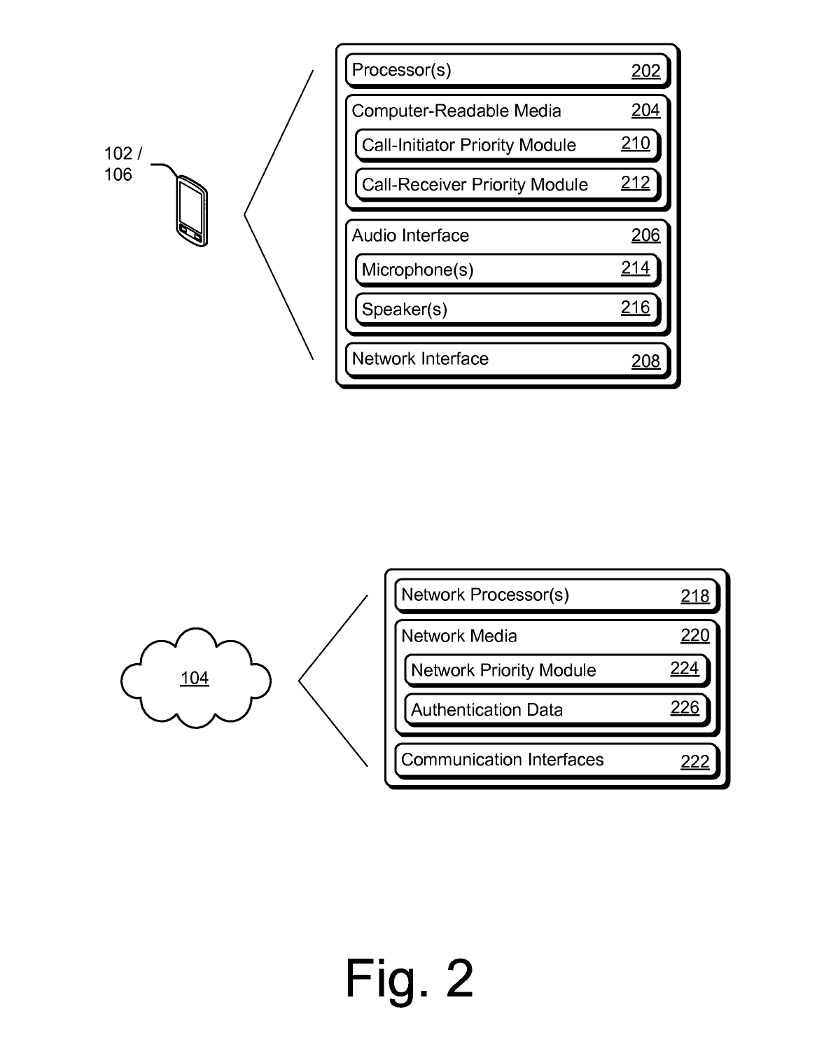

FIG. 2 illustrates a detailed example of calling device 102, communications network 104, and receiving device 106, all of FIG. 1. Note that both calling device 102 and receiving device 106 can be of various types, including basic telephones, and thus do not necessarily include some of the elements as illustrated.

As illustrated, however, calling device 102 and receiving device 106 include processor(s) 202, computer-readable media 204, an audio interface 206, and a network interface 208. Computer-readable media 204 includes a call-initiator priority module 210 (at least for some of calling devices 102, though it may also be part of receiving device 106) and a call-receiving priority module 212 (at least for some of receiving devices 106, though it may also be part of calling device 102).

Call-initiator priority module 210, hereinafter “calling module 210,” is capable of providing a priority trigger by which a later entity may determine and/or authenticate a priority for a call. Call-receiver priority module 212, hereinafter “receiving module 212,” is capable of providing a priority response sufficient to indicate that a call has a particular priority or provide some other communication, though it may do either of these in various different ways. Receiving module 212 may also determine if a priority trigger is authentic and determine a priority response based on the priority trigger. Calling module 210 and receiving module 212 will be described in greater detail below.

Audio interface 206 includes microphone(s) 214 and speaker(s) 216. Network interface 208 enables communication between the device and communication network 104, in whole or in part, such as a wireless network interface, a telephone cable, or an Internet connection.

Communications network 104 includes network processor(s) 218, network computer-readable media (network media) 220, and communication interfaces 222. Communications network 104 may or may not be involved or used by the techniques for priority communication other than to pass information and enable calls themselves. Thus, in some cases communications network 104 simply conveys information without generating or authenticating that information. In this illustrated example, however, communications network 104, through network priority module 224 and authentication data 226 in network media 220, determines, provides, and/or authenticates priority triggers. Communication interfaces 222 enable communication between calling device 102 and receiving device 106.

Generally, any of the entities, techniques, and/or abilities described herein can be implemented using software, firmware, hardware (e.g., fixed-logic circuitry), manual processing, or any suitable combination of these implementations. The example calling module 210, receiving module 212, and network priority module 224 generally represents software, firmware, hardware or any combination thereof. In the case of a software implementation, for instance, these modules represent computer-executable instructions (e.g., program code) that perform specific tasks when executed on a processor (e.g., CPU or CPUs). The program code can be stored in one or more computer-readable memory devices, such as computer-readable media 204 or network media 220. The features and techniques described herein are platform-independent, meaning that they may be implemented on a variety of commercial computing platforms having a variety of processors.

Example Methods for Priority Telephonic Communications

The following discussion describes techniques for priority telephonic communications. Generally, these techniques indicate a priority for a telephone call, thereby enabling a receiving person to better determine whether or not to take the call. Aspects of these methods may be implemented in hardware, firmware, software, or a combination thereof. These methods are shown as sets of blocks that specify operations performed, such as through one or more entities or devices, and are not necessarily limited to the order shown for performing the operations by the respective blocks. In portions of the following discussion reference may be made to environment 100 of FIG. 1 as well as example entities of environment 100 illustrated in FIG. 2, by way of example and not limitation.

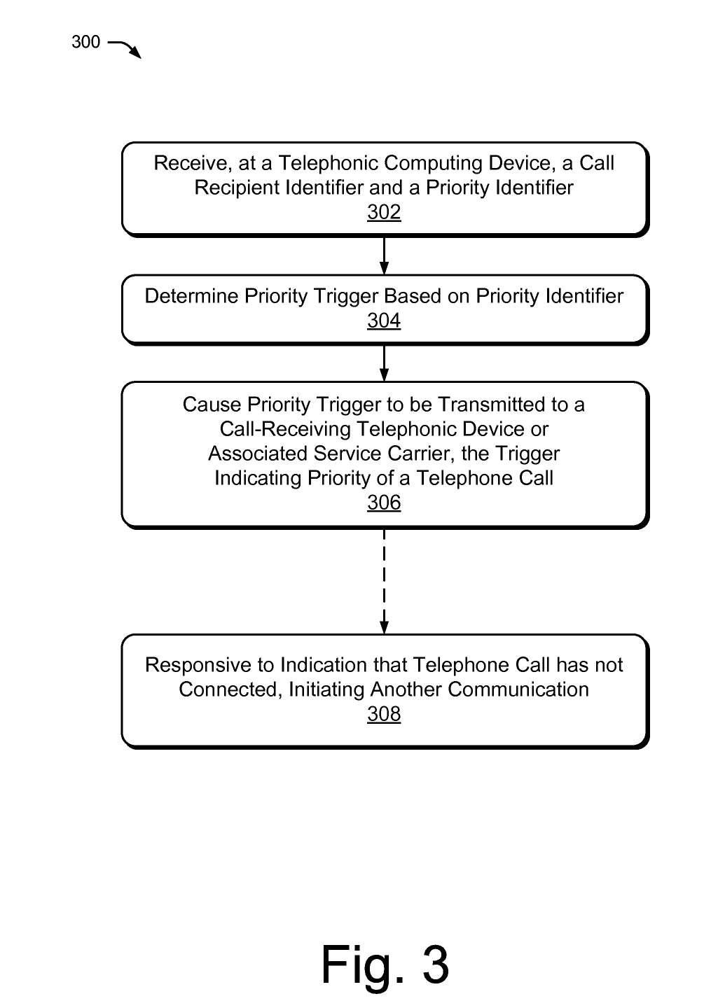

FIG. 3 is a flow diagram depicting example methods 300 for priority telephonic communications from the perspective of a call-initiating telephonic device having computational abilities, such as a cellular phone, smartphone, mobile computer, desktop computer having VOIP capabilities, or a media device having telephonic abilities.

Block 302 receives, at a call-initiating telephonic computing device, a call recipient identifier and a priority identifier. The priority identifier can be received by the call-initiating telephonic computing device prior to, commensurate with, or immediately following the call recipient identifier.

A call recipient identifier includes information by which a person or telephonic device associated with the person can be identified, such as by the call-initiating telephonic device. In some cases it is simply a person's name or telephonic device's telephone number entered or selected through the device. In some other cases the call-recipient identifier is an audio command, a hot key, or the like.

A priority identifier identifies, or can be used to identify, a priority for the call. This priority identifier may be as simple as a number or text spoken, typed, or otherwise selected by the person initiating the call and into the initiating device, e.g., “1.” The priority identifier may be verifiable in some cases, such as entry of a password by the caller. In some cases instead a previously entered password or identifier is accessible by the device on selection of the priority identifier, thereby alleviating the user of having to enter this password or identifier again.

By way of example, consider again Lydia and her father John. Assume here that Lydia issues an audio command to her smart phone to “Call Dad, it is an emergency.” Lydia's smart phone's initiator module 210 determines, based on this audio command, three phone numbers associated with John and that the call is a highest priority. Lydia's smartphone's initiator module 210 also determines a password previously entered by Lydia that is associated with a selection to make the call a highest priority. Thus, the telephonic computing device, whether directly entered or determined by the device, receives both a call recipient identifier and a priority identifier.

Block 304 may determine a priority trigger based on the priority identifier, though in some cases a priority trigger can be determined by another entity, be previously stored and thus not determined at this time, be the priority identifier received, or be a simple indication of priority. Block 304 may make the priority trigger cryptographically secure, though this is not required.

For example, block 304 may encrypt the priority trigger with a previously-received password associated with the call reception device and sufficient to enable the priority trigger to be determined to be authentic by the call reception device. Or block 304 may determine the priority trigger by encrypting the priority trigger with an identifier unique to the telephonic computing device making the call, thereby enabling the call reception device to determine that the encrypted priority trigger is associated with a person from which priority communications can be received.

In the ongoing embodiment, initiator module 210 receives a command indicating a highest priority, locates a password stored in computer-readable media 204 associated with the call recipient (John) and the priority, and determines a cryptographically secure priority trigger. The priority trigger in this case is made cryptographically secure using the password as a key in a public/private key pair-based cryptography.

Block 306 causes the priority trigger to be transmitted to a call reception device or service carrier associated with the call recipient identifier, the priority trigger indicating a priority of a telephone call. Block 306 may act responsive to receiving the priority identifier at block 302 or determining the priority trigger at block 304.

Block 306 may cause the priority trigger to be transmitted to a service carrier also or instead of transmitting the trigger to the call reception device. Some call reception devices are basic telephones or otherwise are unable to receive or understand the priority trigger. In such cases, it is useful to transmit the priority trigger to the service carrier (e.g., network priority module 224) to cause the service carrier to alter a volume, ring tone, or otherwise cause the telephone call to be received or made in a different way. Various ways in which this may be performed are described in greater depth and breadth as part of other methods below.

As noted, the priority can be of various levels, such a high or highest, though various priorities may be set, including a low priority. A friend may just want to chat about nothing important and not want to disturb their friend if the friend is busy. Setting a low priority to a call helps the receiving friend know better whether or not to take the call.

Further, a priority may permit a call to be received at all, or a call to be received with a ring volume rather than silently, and so forth. Thus, a user may set his or her call-receiving telephonic device to have no volume or to automatically go to voicemail, either at or for a particular time or by default. In such a case, a higher priority is required for the call to be received or to have a ring volume.

Concluding the ongoing example, initiator module 210 sends a text message to John's cellphone (which is one of the three numbers associated with John in Lydia's smartphone) immediately before, concurrently, or immediately after initiating a telephone call to John's cellphone. This text message includes the cryptographically secure priority trigger determined above. Ways in which a receiving device, such as John's cellphone, may respond to this trigger are set forth elsewhere herein.

Methods 300 may proceed to block 308 if the intended recipient does not pick up the call. Block 308 initiates another communication, such as an email, text message, repeat of the prior call, another priority call to a different number, or a non-priority call responsive to an indication that the priority call has not connected.

By way of example, consider again the example above. Assume that call-initiating telephonic computing device 102-2 calls John's cellphone but that John's cellphone does not connect after a certain number of rings or that his cellphone goes to voicemail. Initiator module 210 may then proceed to call the other telephone numbers associated with John, such as his office line and the like, including without further selection by the caller (Lydia). These other telephone numbers may be handled similarly to the first call and according to method 300 to indicate a highest priority for the subsequent calls, or initiator module 210 may treat them as a normal call.

Initiator module 210 may, however, cause other types of communications to be initiated, such as by causing an email application to send an email to John's email address or a text application to send a text message to John's cellphone indicating that Lydia is attempting to make a priority communication, though tweets, instant messages, and other communications may also or instead be made.

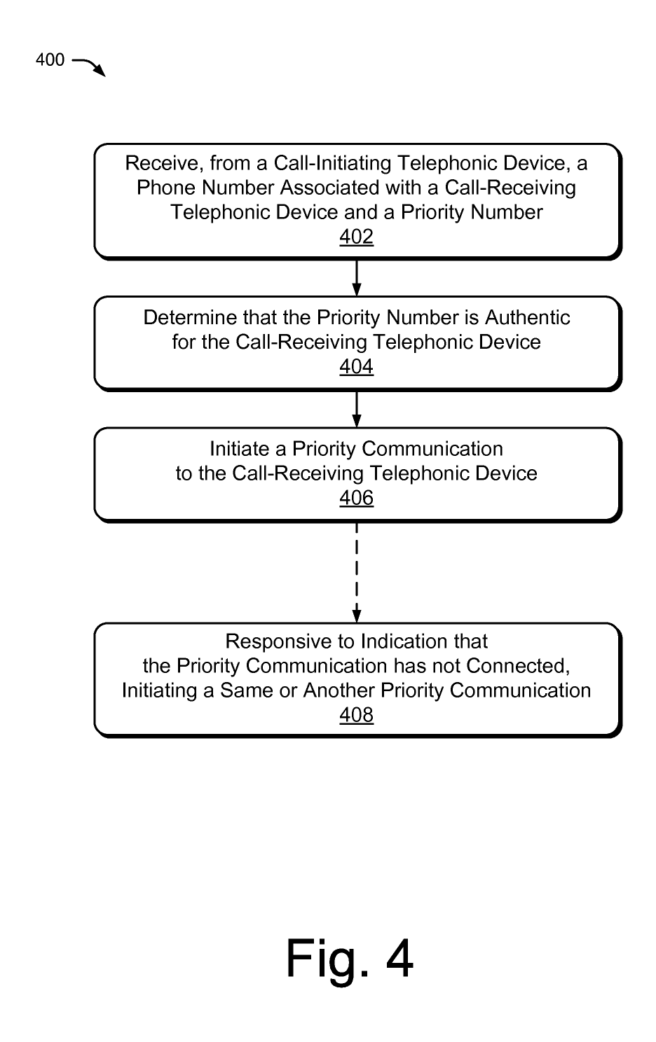

FIG. 4 is a flow diagram depicting example methods 400 for priority telephonic communications from the perspective of an entity acting between a caller and a receiver, such as an entity operating within a communications network. Methods 400 may operate with one or both of a caller and receiver being basic telephones, though that is not required.

Block 402 receives, from a call-initiating telephonic device, a phone number associated with a call-receiving telephonic device and a priority number. As noted in part elsewhere herein, the call-initiating telephonic device can be a basic telephone, such as 102-1 of FIG. 1. Further, the call-receiving telephonic device may also be a basic telephone, such as 106-1 of FIG. 1, or otherwise.

Assume, by way of example that Neilish wants to call his best friend Calvin from his cordless phone at home. Here assume that Neilish's cordless phone is not capable of sending or receiving text messages. Assume also the Neilish wants to communicate with Calvin right away, and so Neilish enters Calvin's home phone number and then a priority number “3682.” An entity in communication network 104, here network priority module 224 of FIG. 2, receives the recipient number and the priority number.

Block 404 determines that the priority number is authentic for the call-receiving telephonic device. Block 404, rather than permit callers to set a priority for a communication that may not be desired by the communication recipient (e.g., from solicitation, marketing, and polling entities), authenticates the priority number prior to initiating a priority communication. Thus, assume that network priority module 224 receives Calvin's home phone number from Neilish's home phone line and determines, based on authentication data 226 having one or more previously stored priority numbers for Calvin's phone number that include the entered priority number “3682,” that the priority number is authentic for Calvin's phone number. The recipient, here Neilish, can revoke this ability of a caller to set a priority by revoking a priority number or other indicator, or specifically for the person calling based on an identity of the caller's device or the person using the device.

Block 406 initiates a priority communication to the call-reception telephonic device. This priority communication is of a different type or received by the call-reception telephonic device in a different way than a telephone call received without the priority number, or in some way is indicated to be of a particular priority. Block 406, for example, may cause the receiving device to have a different ring tone or volume. Block 406 may instead or also cause the call-receiving telephonic device, if it is capable of receiving text or other non-call communications, to instead receive such a text or other communication. This text could indicate, for example, the phone number or name associated with the call-initiating telephonic device and a priority of the message, such as “555-1212 High Priority Call” or “Neilish Called, High Priority.” Note also that in so doing the techniques permit a non-text-capable telephone to send a text message to a text-capable device, as well as other communications not possible for some call-initiating telephonic devices.

Further, block 406 may initiate priority communication in more than one way with a single receiving device and with more than one device associated with a person. Thus, in a case where a television or other media device is known to be associated with the person being called, network priority module 224 may cause the phone to ring and the television to be muted and present a pop-up window or other visual to indicate the priority communication.

Returning to the ongoing example, consider two possible ways in which block 406 may act. In the first, assume that network priority module 224 determines or assumes that Calvin's call-reception telephonic device is a basic telephone (e.g., 106-1 of FIG. 1). In such a case, network priority module 224 causes Calvin's phone to ring repeatedly or continuously (e.g., not go to voicemail), louder than normal, or with a different ring tone. In the second, assume that network priority module 224 determines or assumes that Calvin's call-reception telephonic device is a smartphone, such as 106-2 of FIG. 2. In such a case, network priority module 224 causes Calvin's smartphone to receive a text message, vibrate, and/or have a different ring volume or tone.

Methods 400 may proceed to block 408, similarly to as noted for block 308 of methods 300, if the priority communication has not connected. A communication can be deemed connected if the recipient picks up the phone, opens an email, opens or responds to a text, and so forth. Thus, if the priority communication is a telephone call, responsive to an indication that the telephone call has been sent to voicemail, network priority module 224 may initiate another call to the same phone number or a different priority communication to the same call-reception telephonic device or some other communication device associated with the person, including as indicated above.

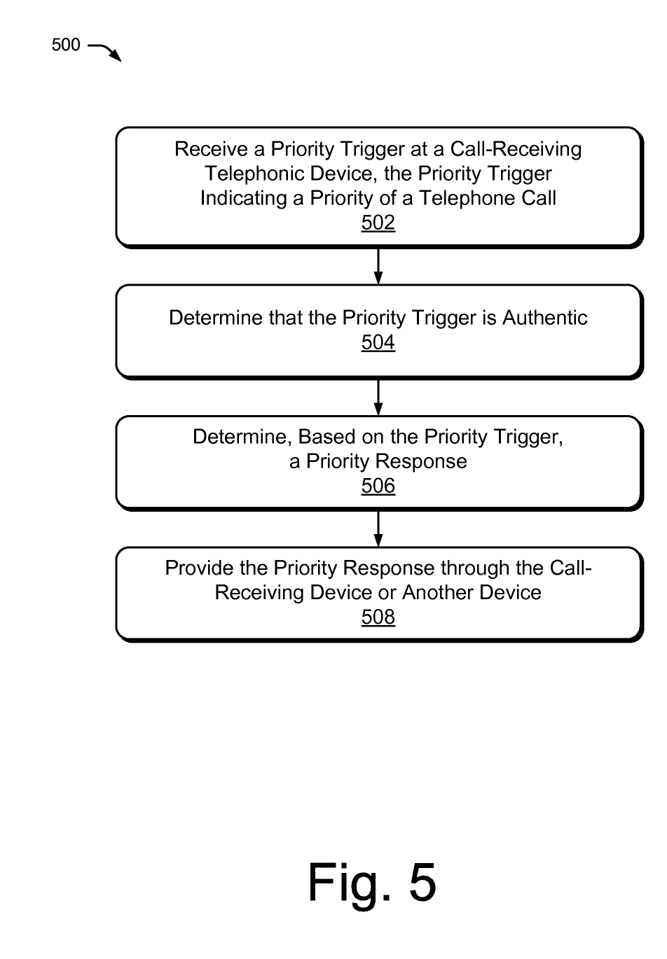

FIG. 5 is a flow diagram depicting example methods 500 for priority telephonic communications from the perspective of a call-receiving telephonic computing device, such as smart phone call-receiving telephonic device 106-2 of FIG. 2.

Block 502 receives a priority trigger at a call-receiving telephonic device, the priority trigger indicating a priority of a telephone call just received, concurrently received with the priority trigger, or imminently to be received at the call-receiving telephonic device. The priority trigger can be one of the many types and received in various manners as set forth above, such as a number received from a telephone service carrier, an encrypted trigger from a carrier or intermediate entity, or a call-initiating telephonic device received as a text message or other non-telephonic communication, to name just a few.

Block 504 determines that the priority trigger is authentic. As noted above, a receiving device may not wish to have priority given indiscriminately to telephonic communications being received, as some callers (advertisers, etc.) might abuse this capability. In such a case, methods 500 authenticate the priority trigger prior to providing a priority response based on the priority trigger. In the case of the priority trigger being received as a text message or similar, non-telephonic communication, receiver module 212 of FIG. 2 parses the text received and then compares the text to one or more authentication passwords to determine if it is authentic. If the text is encrypted, receiver module 212 may perform a cryptographic operation to decrypt the text as part of authentication. However received, the priority trigger may include some text that is not intended for authentication but instead indicates or is a message intended for the receiving device, as discussed below.

Optionally, block 504 may determine that the priority trigger is authentic based on an identity of a device from which the telephone call was initiated. Thus, the priority trigger may be received and either an indicator of the initiating device is received or the telephone call is received with caller ID, and in so doing the priority trigger may be authenticated in part or solely based on the identity of the initiating device. Assume, for example, that Lydia is calling her Dad John. Further, that John's smartphone receives, with the telephone call, a caller ID indicating that Lydia is calling. Even if the priority trigger does not match a previously-set authentication password or is not encrypted, priority module 212 on John's smartphone may still determine the priority trigger to be authentic.

Block 506 determines, based on the priority trigger, a priority response. The priority response may be rather simple and simple to determine, such as in a case where a receiving device is set to only two ways of receiving a call, e.g., a standard ring for a standard call and a loud ring with vibration for a priority call. In such a case the determination is binary.

In some cases, however, determining the priority response is not binary. Consider again the case where at least a portion of text within a text message having a priority trigger indicates a desired priority response or other information. Receiver module 212 may then parse this text from the text message and determine the priority response based on the text. The priority response may be a visual display in conjunction with (on a same or different device associated with the called person) showing the parsed text. Continuing the example above, assume that Lydia selects her call to her Dad to be high priority and with the following text “I'm home safe.” In such a case, receiver module 212 interrupts a current call at John's smartphone, rings the smartphone, and displays the text on the smartphone's display. Note that if Lydia instead selected a low priority with this text, receiver module 212 may instead not interrupt the call, not ring the call or reduce the ring volume below a standard volume, but still display the text.

Block 508 provides the priority response through the call-receiving telephonic device or another device associated with the call-receiving telephonic device and indicating a priority of the telephone call. As noted in part above, the priority response can be received with the telephone call at the receiving device or alter how the call is received, such as through volume and ring tone changes. The priority response may also indicate information, such as text, which may accompany the telephone call or be presented without a call, and/or be presented on another device.

As noted, receiver module 212 may provide a priority response to other devices. Consider a case where a media consumption device is associated with the same person as the receiving device being called. In such a case, receiver module 212 may cause the media consumption device to interrupt media being played or presents a message on the media consumption device.

For example, assume that Neilish again calls Calvin, and that Calvin is playing a loud video game. Calvin may not hear the higher priority ring or see a text on his phone (if it can display text), but the techniques may provide the priority response through multiple devices associated with Calvin, such as the gaming device he is playing. Here assume that receiver module 212 pauses the game and displays on the gaming device's screen “Neilish—Priority Call.” Calvin may use this information to better determine whether or not to pick up the call—he now knows who is calling and the priority of the call.

The preceding discussion describes methods relating to priority telephonic communications. Aspects of these methods may be implemented in hardware (e.g., fixed logic circuitry), firmware, software, manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable memory devices, both local and/or remote to a computer processor. The methods may also be practiced in a distributed computing mode by multiple computing devices.

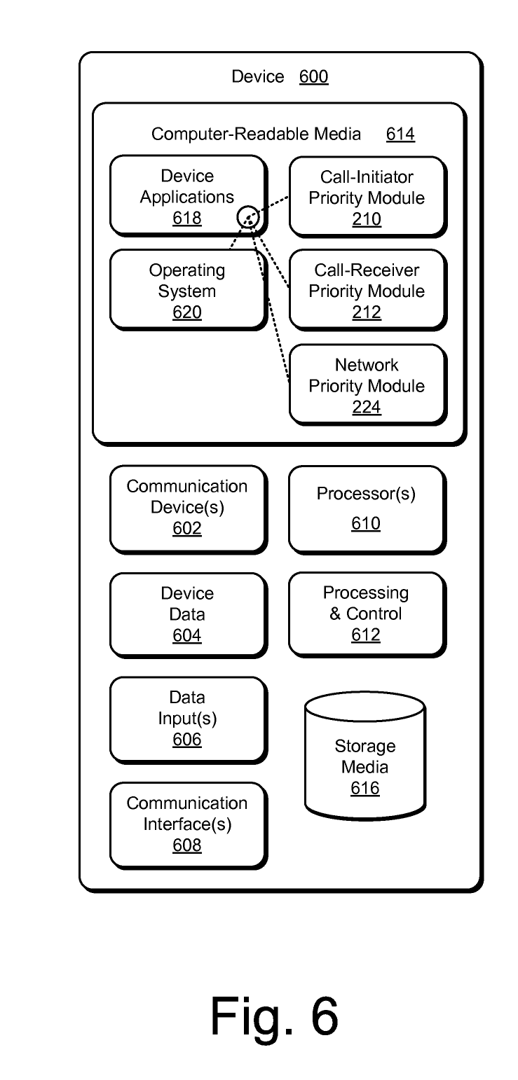

These techniques may be embodied on one or more of the entities shown in FIGS. 1, 2, and 6 (device 600 is described below), which may be further divided, combined, and so on. Thus, these figures illustrate some of many possible systems or apparatuses capable of employing the described techniques. The entities of these figures generally represent software, firmware, hardware, whole devices or networks, or a combination thereof. In the case of a software implementation, for instance, the entities (e.g., initiator module 210, receiver module 212, and network priority module 224) represent program code that performs specified tasks when executed on a processor (e.g., processor(s) 202 and/or 218). The program code can be stored in one or more computer-readable memory devices, such as media 204 and/or 220 or computer-readable media 614 of FIG. 6.

Example Device

FIG. 6 illustrates various components of example device 600 that can be implemented as any type of client, server, and/or computing device as described with reference to the previous FIGS. 1-5 to implement techniques enabling priority telephonic communications. In embodiments, device 600 or portions thereof can be implemented as one or a combination of a wired and/or wireless device, a System-on-Chip (SoC), as a form of a television computing device (e.g., television set-top box, digital video recorder (DVR), etc.), consumer device, computer device, server device, portable computer device, user device, communication device, video processing and/or rendering device, appliance device, gaming device, electronic device, and/or as another type of device. Device 600 may also be associated with a user (e.g., a person) and/or an entity that operates the device such that a device describes logical devices that include users, software, firmware, and/or a combination of devices.

Device 600 includes communication devices 602 that enable wired and/or wireless communication of device data 604 (e.g., received data, data that is being received, data scheduled for broadcast, data packets of the data, etc.). The device data 604 or other device content can include configuration settings of the device, media content stored on the device (e.g., media programs 210), and/or information associated with a user of the device. Media content stored on device 600 can include any type of audio, video, and/or image data. Device 600 includes one or more data inputs 606 via which any type of data, media content, and/or inputs can be received, such as human utterances, user-selectable inputs, messages, music, television media content, recorded video content, and any other type of audio, video, and/or image data received from any content and/or data source.

Device 600 also includes communication interfaces 608, which can be implemented as any one or more of a serial and/or parallel interface, a wireless interface, any type of network interface, a modem, and as any other type of communication interface. The communication interfaces 608 provide a connection and/or communication links between device 600 and a communication network by which other electronic, computing, and communication devices communicate data with device 600.

Device 600 includes one or more processors 610 (e.g., any of microprocessors, controllers, and the like), which process various computer-executable instructions to control the operation of device 600 and to enable techniques enabling priority telephonic communications. Alternatively or additionally, device 600 can be implemented with any one or combination of hardware, firmware, or fixed logic circuitry that is implemented in connection with processing and control circuits which are generally identified at 612. Although not shown, device 600 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 600 also includes computer-readable storage media 614, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 600 can also include a mass storage media device 616.

Computer-readable storage media 614 provides data storage mechanisms to store the device data 604, as well as various device applications 618 and any other types of information and/or data related to operational aspects of device 600. For example, an operating system 620 can be maintained as a computer application with the computer-readable storage media 614 and executed on processors 610. The device applications 618 may include a device manager, such as any form of a control application, software application, signal-processing and control module, code that is native to a particular device, a hardware abstraction layer for a particular device, and so on.

The device applications 618 also include any system components, engines, or modules to implement techniques enabling priority telephonic communication. In this example, the device applications 618 can include initiator module 210, receiver module 212, and/or network priority module 224.

### CONCLUSION

Although embodiments of techniques and apparatuses enabling priority telephonic communication have been described in language specific to features and/or methods, it is to be understood that the subject of the appended claims is not necessarily limited to the specific features or methods described. Rather, the specific features and methods are disclosed as example implementations enabling priority telephonic communications.

What is claimed is:

1. A method comprising:
receiving, at a call-initiating telephonic computing device, a call recipient identifier and a priority identifier; and
responsive to receiving the priority identifier, causing a priority trigger to be transmitted to a call-receiving telephonic device associated with the call recipient identifier or a service carrier associated with the call-receiving telephonic device, the priority trigger indicating a priority of a telephone call just received, concurrently received, or imminently to be received by the call-receiving telephonic device.

2. The method as recited in claim 1, further comprising, prior to causing the priority trigger to be transmitted, determining the priority trigger based on the priority identifier.

3. The method as recited in claim 2, wherein determining the priority trigger encrypts the priority trigger with a previously-received password associated with the call-receiving telephonic device, the encryption sufficient to enable the priority trigger to be determined to be authentic by the call-receiving telephonic device or the service carrier.

4. The method as recited in claim 2, wherein determining the priority trigger encrypts the priority trigger with an identifier unique to the call-initiating telephonic computing device, the encryption sufficient to enable the priority trigger to be determined to be from the call-initiating telephonic computing device by the call-receiving telephonic computing device.

5. The method as recited in claim 1, wherein the call-receiving telephonic device is a telephonic computing device capable of receiving text messages and causing the priority trigger to be transmitted to the call-receiving telephonic device sends a text message to the call-receiving telephonic device.

6. The method as recited in claim 1, wherein:
the call-receiving telephonic device is a basic telephone, the basic telephone unable to perform computations or receive texts or emails;
causing a priority trigger to be transmitted causes the priority trigger to be transmitted to the service carrier associated with the call-receiving telephonic device; and
the priority trigger is capable of causing the service carrier to alter a volume or ring tone of the basic telephone.

7. A method comprising:
receiving a priority trigger at a call-receiving telephonic computing device, the priority trigger indicating a priority of a telephone call just received, concurrently received with the priority trigger, or imminently to be received at the call-receiving telephonic computing device;
determining that the priority trigger is authentic;
determining, based on the priority trigger, a priority response; and
providing the priority response through the call-receiving telephonic computing device or another device associated with the call-receiving telephonic computing device, the priority response indicating a priority of the telephone call.

8. The method of claim 7, wherein the priority trigger is a text message and determining that the priority trigger is authentic is based on text parsed from within the text message.

9. The method of claim 7, wherein the priority trigger is included within a text message, the priority response includes at least a portion of text within the text message, and providing the priority response displays the portion of the text on a display associated with the call-receiving telephonic computing device.

10. The method of claim 7, wherein the priority trigger is a number received from a telephone service carrier after reception of the telephone call and determining that the priority trigger is authentic determines that the number matches one of one or more previously-set authentication passwords.

11. The method of claim 7, wherein determining that the priority trigger is authentic is based on an identity of a device from which the telephone call was initiated.

12. The method of claim 7, wherein determining the priority response is further based on an identity of a device from which the telephone call was initiated.

13. The method of claim 7, wherein providing the priority response interrupts another call at the call-receiving telephonic computing device, causes a loud ring at the call-receiving telephonic computing device, or displays text or a text message in conjunction with indicating reception of the call.

14. The method of claim 7, further comprising causing another device to indicate the priority response or another priority response, the other device associated with the call-receiving telephonic computing device.

15. The method of claim 14, wherein the other device is a media consumption device and causing the other device to indicate causes the media consumption device to interrupt media being played on the media consumption device or presents a message on the media consumption device.

16. A method comprising:
receiving, from a call-initiating telephonic device, a phone number associated with a call-receiving telephonic device and a priority number;
determining that the priority number is authentic for the call-receiving telephonic device; and
initiating a priority communication to the call-receiving telephonic device, the priority communication of a different type or received by the call-receiving telephonic device in a different way than a telephone call received without the priority number.

17. The method as recited in claim 16, wherein the call-initiating telephonic device is a basic telephone not having an ability to transmit text messages.

18. The method as recited in claim 17, wherein the call-receiving telephonic device is a computing device having an ability to receive text messages and initiating a priority communication initiates the priority communication of the different type, the different type being a text message determined by a service carrier based on the priority number and indicating the call-initiating telephonic device.

19. The method as recited in claim 16, wherein initiating a priority communication initiates the priority communication in the different way, the different way being a different ring or ring volume initiated by a service carrier to the call-receiving telephonic device.

20. The method as recited in claim 16, wherein initiating a priority communication initiates the priority communication in the different way and as a telephone call and further comprising, responsive to an indication that the telephone call has been sent to voicemail, initiating the same or another priority communication to the call-receiving telephonic device.
